(19) United States
(12) Patent Application Publication
(10) Pub. No.: US 2009/0193929 A1
(43) Pub. Date: Aug. 6, 2009

(54) Foldable Control Lever Structure Of Motorcycle Handle

(76) Inventor: Chen-Feng Lin, Changhua City (TW)

Correspondence Address: RABIN & Berdo, PC, 1101 14TH STREET, NW, SUITE 500, WASHINGTON, DC, 20005, US

(21) Appl. No.: 12/025,911

(22) Filed: Feb. 5, 2008

(51) Int. Cl. G05G 1/04

(52) U.S. Cl. 74/522

(57) ABSTRACT

The invention is related to a foldable control lever structure of motorcycle handle which mainly comprises a control lever, a pivot base and a pivot set, wherein said pivot base is pivotally combined with said control lever enabling said control lever to relatively perform 0-90 degrees pivotally folding effect, thereby said control lever can be properly folded without causing damage in case of motorcycle falling down causing the control lever to hit the ground, and further through pivotal offset between said pivot base and pivot set matching with the external top-pushing spring and internal adjuster buttoning bolt design, relative relationship between said control lever and said motorcycle handle grip can be micro-adjusted according to palm size difference of riders, thereby to obtain best handiness of operation.

### BACKGROUND OF THE INVENTION

(a) Field of the Invention

The invention is related to a foldable control lever structure of motorcycle handle, wherein the control lever is constituted by three components to allow the control lever to perform a folding upward function, so that said control lever can be properly folded without causing damage in case of motorcycle falling down causing the control lever to hit the ground. Through pivotal offset between said pivot base and pivot set matching with the external top-pushing spring and internal adjuster buttoning bolt design, relative relationship between said control lever and said motorcycle handle grip can be micro-adjusted according to palm size difference of riders, thereby to obtain best handiness of operation and to effectively resolve the existing problems and imperfections of known products of the like.

(b) Description of the Prior Art

In general, the two handle grips of a motorcycle are usually attached with control levers which is not only used in front, rear wheel braking function, the control lever at the right hand side is also additionally used for clutching function to permit engine startup by pressing the startup button.

Control levers of said motorcycle handles of the like are generally made of aluminum alloy or cast iron which is harder but brittle. Further, said control levers are mostly attached externally to the motorcycle handle grip, therefore in case of unexpected motorcycle falling down, the control lever of motorcycle handle is easy to break when hitting the ground before the handle grip does, thereby results in loss of control lever functions that not only affects transportation safety but also cause additional expense for needing to purchase new products, therefore such designs can not be considered ideal and methods for improvements shall be looked for.

In addition, control levers for said motorcycle handles are usually made to fixed relationships, however, as human palm sizes are varied individually, said fixed type relationship between control lever and handle grip may be too wide for people with smaller palms to hold properly, and too narrow for people with bigger palms, who may have to slightly bend their palms from time to time in order to cope with unexpected occurrence of needs. In other words, no matter for bigger or smaller palms, operating handiness for said control lever is hard to obtain, therefore methods for improvement are necessary.

### SUMMARY OF THE INVENTION

Regarding the existing problems and imperfections in control levers of motorcycle handle, the inventor has been based on his many years of experiences and skills doing research and improvements to invent the invented foldable control lever of motorcycle handle. i.e. whereby through its structural assembly design, the control lever is effected to pivotally fold up 0-90 degrees, so that when it is impacted by external forces, said control lever can be folded accordingly to avoid hard contact thereof resulting in breaking damages.

Another purpose of the invention is that through the structure assembly design of control lever, relative relationship between control lever and motorcycle handle grip can be adjusted concurrently according to the palm size of the rider, thereby to obtain the best handiness of operation.

To achieve above said disclosed purposes, the invented structure is mainly designed to be constituted by three-pieces assembly including control lever, pivot base and pivot set, wherein control lever is made with a 0-90 degrees pivotal effect relative to pivot base, so that in case of motorcycle falling down causing said control lever to hit the ground, said control lever is folded properly to avoid breaking damages, while through pivotal offset between said pivot base and pivot set matching with the external top-pushing spring and internal adjuster buttoning bolt design, relative relationship between said control lever and said motorcycle handle grip can be micro-adjusted according to palm size difference of riders, thereby to obtain best handiness of operation and to effectively resolve the existing problems and imperfections between the know products of the like.

### BRIEF DESCRIPTION OF THE DRAWINGS

FIG. 1 is a structure schematic view of a preferred embodiment of the invention.

FIG. 2 is an exploded view of a preferred embodiment of the invention.

FIG. 3 is a schematic view showing structure relationship of a preferred embodiment of the invention.

FIG. 4 is reference view showing the practical application of a preferred embodiment of the invention.

FIG. 5 is structural schematic view showing folded status of control lever in a preferred embodiment of the invention.

FIG. 6 is a structural schematic view showing folding action of control lever in a preferred embodiment of the invention.

FIG. 7 is a structural schematic view showing the micro-adjusting actions on the distance between control lever and motorcycle handle grip.

### DETAILED DESCRIPTION OF THE PREFERRED EMBODIMENTS

Structural composition, arts and effects related to the invention is further described with the accompanying Figs. herein:

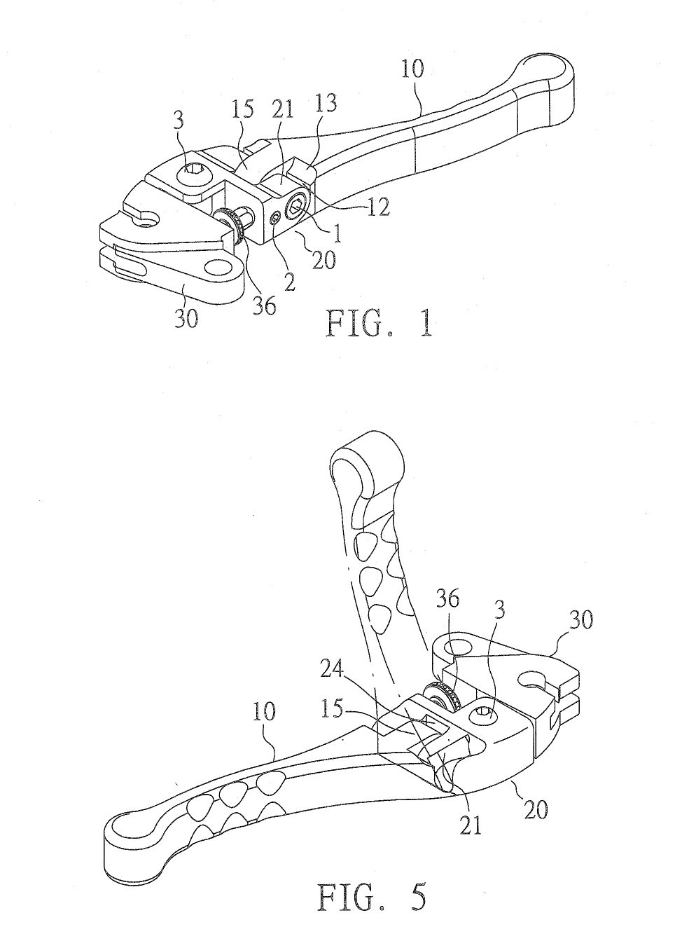

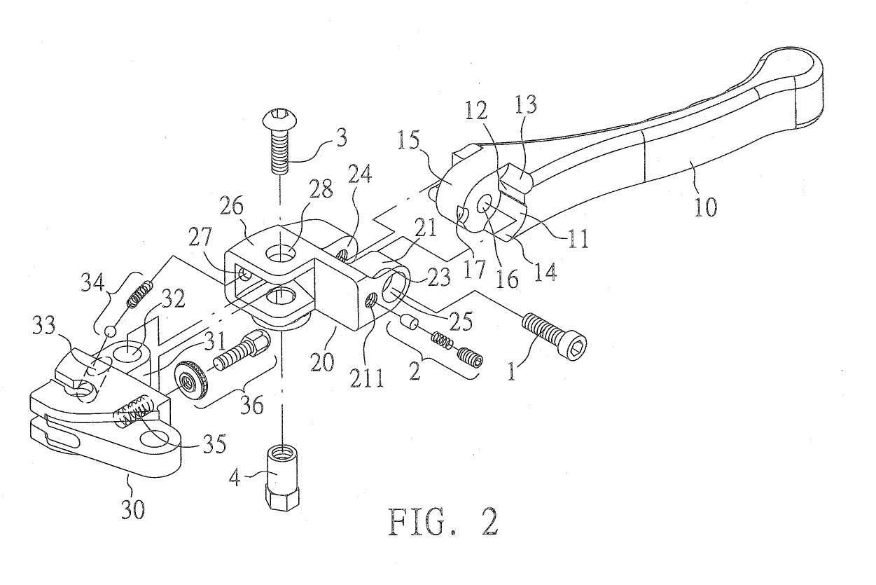

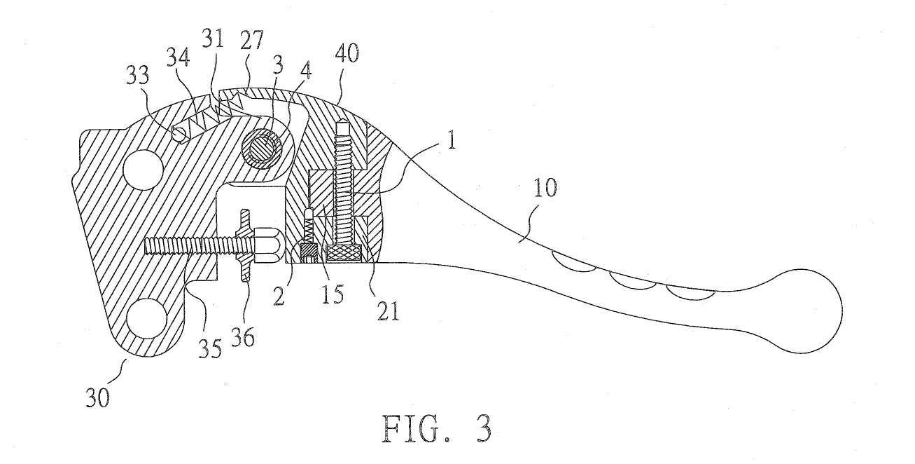

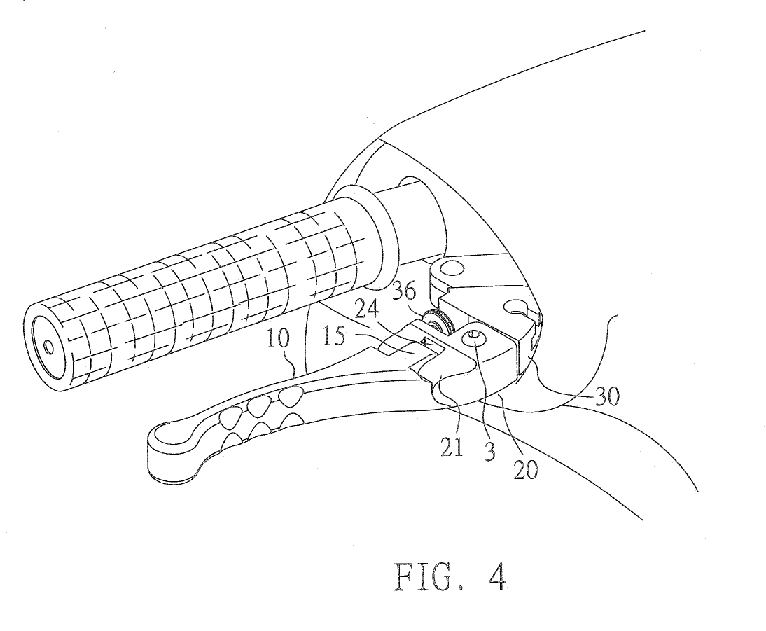

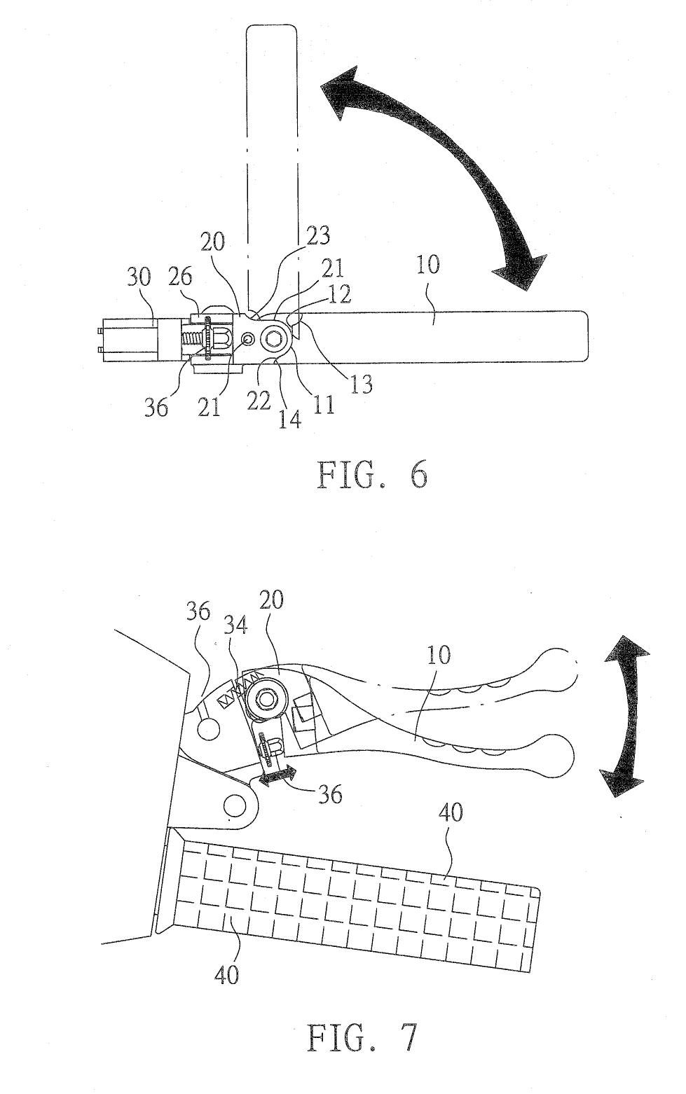

Referring to structural schematic view in FIG. 1, structure exploded view in FIG. 2, structure relationships in FIG. 3, practical application status in FIG. 4, structural schematic view in FIG. 5 and schematic view of relative actions in FIGS. 6, 7 which are a preferred embodiment of the invention, as shown in the Figs., the invented control lever design of motorcycle handle mainly comprises a control lever 10, a pivot base 20, and a pivot set 30, wherein:

Said control lever 10 is made with an upward arc concave 11 at one end of the base portion thereof, wherein top edge of said arc concave 11 is continuously made with a stopping raised face 12, and a cut arc 13 is further made above said stopping raised face 12. Said arc concave 11 is continuously formed with a stopping portion 14 at the bottom edge thereof and protrudingly made with a longitudinal extending portion 15 in the middle thereof, which has a axis hole 16 for passing through by bolting axle 1 to pivotally connect with pivot base 20. Said extending portion 15 is further installed with a locking slot 17 thereon at another end thereof to fit with a locking spring set 2 to lockingly limit the relationship between control lever 10 and pivot base 20;

Said pivot base 20 is installed with a pivot hub 21 at one end thereof, outer edge of said pivot hub 21 is made with an arc face to fit with arc concave 11 of control lever 10, wherein said arc face is continuously made with a stopping portion 22 at top edge thereof, edge of said stopping portion 22 thereof is further chamfered for guiding arc concave, and the bottom edge thereof is made with a limiting stop face 23. A longitudinal cut slot 24 is made at middle of pivot hub 21 to fit with extending portion 15 of control lever 10. Further, said pivot hub 21 is penetratingly made a axis hole 25, whereby pivot base 20 and control lever 10 is pivotally combined by bolting axle 1. The said pivot hub 21 of pivot base 20 is made with a slot hole 211 at a designated position of one side thereof to attach with a locking spring set 2, whereby said locking spring set 2 is matched with the locking slot 17 at one side of extending portion 15 of control lever 10 to define the position relationship between said pivot base 20 and control lever 10. Further, said pivot base is continuously made with a horizontal pivot seat 26 at outer edge of another side thereof, said pivot seat 26 is made with a slot hole 27 inside the slot thereof, and penetratingly installed with a pair of axis holes 28 thereon, whereby said pivot base 20 and pivot set 30 are pivotally connected by a screw bolt 3 and a matched axle bush 4.

Said pivot set 30 is assembled to the base position of motorcycle handle grip 40, wherein it is externally installed with an axis portion 31 at one end thereof, said axis portion 31 is made with an axis hole 32 to allow screw bolt 3 matching with axle bush 4 to be pivotally combined inside pivot seat 26 of pivot base 20, thereby to obtain horizontally pivotal offset relationship between pivot base 20 and pivot set 30. At the same time, axis portion 31 of pivot set 30 is externally made with a slot hole 33 and matched with the slot hole 27 at pivot seat 26 of pivot base 20 to house a top-pushing spring 34, whereby said pivot base 20 is pushed by said top-pushing spring 34 to endow said pivot base 20 and its control lever 10 with the inertia of leaning to the motorcycle handle grip 40. Further, a screw hole 35 is provided inside axis portion 31 of pivot set 30 to lockingly installed with a adjuster buttoning bolt 36 which contacts said pivot base 20 at the other end thereof, whereby degree of push on said pivot base 20 by said top-pushing spring 34 is adjusted by said adjuster buttoning bolt 36 so as to achieve the micro-adjustment effect on the relative relationship between control lever 10 and motorcycle handle grip 40;

As disclosed by above structure embodiments, through the longitudinal pivotal design between said control lever 10 and said pivot base 20, said control lever 10 can effected to fold 0-90 degrees upwardly relatively to said pivot base 20. However, it is particularly described herein in that said control lever 10 is made foldable only upwardly in the invented structure design to avoid consequential operating safety concerns on easy folding down of control lever 10 affected by an external force, wherein said stopping portion 14 at bottom edge of arc concave 11 of said control lever 10 is matched with said limiting stop face 23 at arc face bottom edge of pivot hub 21 of pivot base 20 to maintain said control lever 10 and said pivot base 20 at 0° flat limit position, and locking spring set 2 at one side of pivot hub 21 of pivot base 20 is lockingly positioned with locking slot 17 of extending portion 15 of control lever 10 so that flat positioning relationship between control lever 10 and pivot base 20 is strengthened to avoid easy folding by an external force. Once said control lever 10 is impacted by an external force due to motorcycle falling down or an accident, as long as the acting force is bigger than the one of locking spring set 2, said control lever 10 can be effected to fold: upward, wherein stopping raised face 12 at the top edge of arc concave 11 of control lever 10 and stopping portion 14 at arc face top edge of pivot hub 2 of pivot base 20 are mutually pushed to obtain the folding limit, and further through the match between cut arc 13 at top edge of stopping raised face 12 of control lever 10 and the designed guiding edge of stopping portion 22 of pivot base 20 to make said control lever 10 to actually achieve the 90° folding effect, thereby due to the movable folding effect of said control lever 10 particularly in case of motorcycle falling down to contact the ground, said control lever 10 can be properly folded without causing damage so as to elongate its work life and normal operating functions, thus effectively resolves the existing problems and imperfections of the known structures.

In other respect, due to the offset pivotal relationship between pivot base 20 and pivot set 30, pivot base 20 is externally pushed by top-pushing spring 34 to endow said control lever 10 with the inertia of leaning to the motorcycle handle grip 40, whereby through adjustment by adjuster buttoning bolt 36 lockingly installed inside pivot set 30, said pivot base 20 is reversely pushed by said adjuster buttoning bolt 36 so as to change the degree of push by top-pushing spring 34 on pivot base 20. The relative relationship and distance between said pivot base 20 along with its pivotally attached control lever 10 and said motorcycle handle grip 40 can be micro-adjusted, whereby the relationship between said control lever 10 and said motorcycle handle grip 40 can be micro-adjusted according to palm size difference of riders to enhance handiness of operation, therefore it is practically more useful comparing with other known structures.

Through above descriptions, the invention is aiming to improve the structure design for the control lever of motorcycle handle, wherein said control lever is pivotally combined with said pivot base to allow said control lever to perform the 0-90 degree folding effect when impacted by an external force, so that breaking damage losses due to hard hit can be avoided while operating performance can be maintained, thereby to extend work life and reduce the consequential maintenance and repair costs. While through pivotal offset between said pivot base and pivot set matching with the external top-pushing spring and internal adjuster buttoning bolt design, relative distance between said control lever and said motorcycle handle grip can be micro-adjusted according to palm size difference of riders, thereby to obtain best handiness of operation and to effectively resolve the existing problems and imperfections between the know products of the like, so that it is valuable in industrial application and practical usefulness.

As summarized from above descriptions, the foldable control lever structure of the invention, through its innovated design of structure, the foldable control lever structure of the invention not only has the advantage of folding upward the control lever under external force to avoid damage, but is also able to micro-adjust the relationship between control lever and motorcycle handle grip according to palm size of the rider, thereby to obtain the best handiness of operation and to endow very good industrial usefulness and practical values, as such, it is an excellent and outstanding innovated design, therefore the patent application is submitted according to law.

1. A foldable control lever structure of motorcycle handle comprises at least a control lever, a pivot base, and a pivot set, wherein
Said control lever is made with an upward arc concave at one end of the base portion thereof, wherein top edge of said arc concave is continuously made with a stopping raised face. Said arc concave is continuously formed with a stopping portion at the bottom edge thereof and protrudingly made with a longitudinal extending portion in the middle thereof, which has a bolt hole for passing through by bolting axle 1 to pivotally connect with pivot base;
Said pivot base is installed with a pivot hub at one end thereof, outer edge of said pivot hub is made with an arc face to fit with arc concave of control lever, wherein said arc face is continuously made with a stopping portion at top edge thereof, bottom edge thereof is made with a limiting stop face at the middle of pivot hub to match with longitudinal cut slot of extending portion, wherein said pivot hub is penetratingly made with a axis hole to pivotally connect pivot base and control lever;
As disclosed, through the longitudinal pivotal relationship between said control lever and said pivot base, said control lever can effected to fold 0-90 degrees upwardly relatively to said pivot base, thereby said control lever can be properly folded without causing damage in case of motorcycle falling down causing said control lever to hit the ground.

2. The foldable control lever structure of motorcycle handle as claimed in claim 1, wherein said extending portion at middle of control lever arc cave is further made with a locking slot at another end thereof, and said pivot hub of pivot base is made with a slot hole at a designated position of one side thereof for housing a locking spring set, thereby said locking spring set is fitted with said locking slot located at one side of said pivot hub to particularly strengthen the 0° flat positioning relationships between said pivot base and said control lever.

3. The folded control lever structure of motorcycle handle as claimed in claim 1, wherein top edge of said arc concave of control lever is continuously made with a stopping raised face, and a cut arc is further made above said stopping raise face. At the same time, said arc face of pivot hub of pivot base is continuously made with a stopping portion at top edge thereof, edge of said stopping portion thereof is further chamfered for guiding arc concave, thereby to obtain a 90° folding effect for control lever.

4. A foldable control lever structure of motorcycle handle as claimed in claim 1, comprises at least a control lever, a pivot base, and a pivot set, wherein:
Said control lever is made with an upward arc concave at one end of the base portion thereof, wherein top edge of said arc concave is continuously made with a stopping raised face. Said arc concave is continuously formed with a stopping portion at the bottom edge thereof and protrudingly made with a longitudinal extending portion in the middle thereof, which has a bolt hole for passing through by bolting axle 1 to pivotally connect with pivot base;
Said pivot base is installed with a pivot hub at one end thereof, outer edge of said pivot hub is made with an arc face to fit with arc concave of control lever, wherein said arc face is continuously made with a stopping portion at top edge thereof and the bottom edge thereof is made with a limiting stop face. A longitudinal cut slot is made at middle of pivot hub to fit with extending portion of control lever. Further, said pivot hub is penetratingly made a axis hole, whereby pivot base and control lever is pivotally combined by bolting axle. Further, said pivot base is continuously made with a horizontal pivot seat at outer edge of another side thereof, said pivot seat is made with a slot hole inside the slot thereof and penetratingly installed with a pair of axis holes thereon, whereby said pivot base and pivot set are pivotally connected by a screw bolt and a matched axle bush;
Said pivot set is assembled to the base position of motorcycle handle grip, wherein it is externally installed with an axis portion at one end thereof, said axis portion is made with an axis hole to allow screw bolt matching with axle bush to be pivotally combined inside pivot seat of pivot base, thereby to obtain horizontally pivotal offset relationship between pivot base and pivot set. At the same time, axis portion of pivot set is externally made with a slot hole and matched with the slot hole at pivot seat of pivot base to house a top-pushing spring, whereby said pivot base is pushed by said top-pushing spring to endow said pivot base and its control lever with the inertia of leaning to the motorcycle handle grip. Further, a screw hole is provided inside axis portion of pivot set to lockingly installed with a adjuster buttoning bolt which contacts said pivot base at the other end thereof, whereby degree of push on said pivot base by said top-pushing spring is adjusted by said adjuster buttoning bolt so as to achieve the micro-adjustment effect on the relative relationship between control lever and motorcycle handle grip;
As disclosed, through the movable pivotal relationship between said control lever and said pivot base, said control lever is particularly endowed with a folding upward function, so that said control lever can be properly folded without causing damage in case of motorcycle falling down causing said control lever to hit the ground. Further, through pivotal offset between said pivot base and pivot set matching with the external top-pushing spring and internal adjuster buttoning bolt design, relative distance between said control lever and said motorcycle handle grip can be micro-adjusted according to palm size difference of riders, thereby to obtain best handiness of operation.

5. The foldable control lever structure of motorcycle handle as claimed in claim 4, wherein said extending portion at middle of control lever arc cave is further made with a locking slot at another end thereof, and said pivot hub of pivot base is made with a slot hole at a designated position of one side thereof for housing a locking spring set, thereby said locking spring set is fitted with said locking slot located at one side of said pivot hub to particularly strengthen the 0° flat positing relationships between said pivot base and said control lever.

6. The folded control lever structure of motorcycle handle as claimed in claim 4, wherein top edge of said arc concave of control lever is continuously made with a stopping raised face, and a cut arc is further made above said stopping raise face. At the same time, said arc face of pivot hub of pivot base is continuously made with a stopping portion at top edge thereof, edge of said stopping portion thereof is further chamfered for guiding arc concave, thereby to obtain a 90° folding effect for control lever.

7. A foldable control lever structure of motorcycle handle is mainly formed by a pivot base and a pivot set which are continuously extended from base end of control lever, wherein it comprises:
Said pivot base of control lever is continuously made with a horizontal pivot seat at outer edge of another side thereof, said pivot seat is made with a slot hole inside the slot thereof, and penetratingly installed with a pair of axis holes thereon, whereby said pivot base and pivot set are pivotally connected by a screw bolt and a matched axle bush;
Said pivot set is assembled to the base position of motorcycle handle grip, wherein it is externally installed with an axis portion at one end thereof, said axis portion is made with an axis hole to allow screw bolt matching with axle bush to be pivotally combined inside pivot seat of pivot base, thereby to obtain horizontally pivotal offset relationship between pivot base and pivot set. At the same time, axis portion of pivot set is externally made with a slot hole to house a top-pushing spring, whereby said pivot base is pushed by said top-pushing spring to endow said pivot base and its control lever with the inertia of leaning to the motorcycle handle grip. Further, a screw hole is provided inside axis portion of pivot set to lockingly installed with a adjuster buttoning bolt which contacts said pivot base at the other end thereof, whereby degree of push on said pivot base by said top-pushing spring is adjusted by said adjuster buttoning bolt so as to achieve the micro-adjustment effect on the relative relationship between control lever and motorcycle handle grip;
As disclosed, through pivotal offset between said pivot base and pivot set matching with the external top-pushing spring and internal adjuster buttoning bolt design, relative distance between said control lever and said motorcycle handle grip can be micro-adjusted according to palm size difference of riders, thereby to obtain best handiness of operation.
